(19) United States
(12) Patent Application Publication
(10) Pub. No.: US 2018/0121617 A1
(43) Pub. Date: May 3, 2018

(54) Treatment Decision Interface Device and Graphical User Interface (GUI)

(71) Applicant: Pinscriptive, Inc., San Juan Capistrano, CA (US)

(72) Inventors: Mark Lelinski, Austin, TX (US); Roni H. Amiel, Sparta, NJ (US)

(21) Appl. No.: 15/338,209

(22) Filed: Oct. 28, 2016

(51) Int. Cl. G06F 19/00

(52) U.S. Cl. CPC G06F 19/325; G06F 19/3456; G06F 19/3406; G06F 19/345

(57) ABSTRACT

A treatment decision interface device includes a hardware processor, a memory, a display, and a graphical user interface (GUI) stored in the memory and executed by the hardware processor to provide a treatment decision main screen on the display enabling a user to navigate among a patient data screen, a treatment query screen, and a reporting screen. The GUI further presents a patient data screen enabling the user to identify a patient and a condition diagnosed in the patient, and to enter patient profiling data for the patient, and also presents a treatment query screen enabling the user to select one or more treatments for the condition. In addition, the GUI presents a reporting screen including a value score for each of the treatments selected via the treatment query screen, the value score corresponding respectively to a value of each of the treatments for treating the condition.

### BACKGROUND

Advances in pharmaceutical and basic medical research have resulted in the availability of new medications and new treatment protocols that give hope to many patients who previously had faced a bleak health future. However, many of these cutting edge treatments are extremely costly, and leave insurers and other entities responsible for paying for patient care in the unenviable position of facing unsustainable costs, or restricting access to powerful and beneficial treatments.

For example, specialty pharmaceutical drugs being introduced for use in the treatment of cancer, cystic fibrosis, multiple sclerosis, rheumatoid arthritis, and hepatitis C may cost anywhere from approximately ten thousand to approximately one hundred thousand dollars for a full course of treatment. Moreover, the growth in cost of such specialty drugs is projected to by in the range of fifteen to twenty percent per year, thereby rapidly making already expensive treatments practically unaffordable. Despite their nearly prohibitive costs, however, these specialty drugs benefit the sickest, most severely ill patients, so that simply denying access to them due to their cost is not an appropriate solution.

One significant factor encouraging insurers and other healthcare payers to attempt to deny access to specialty drugs and other expensive treatment modalities, is the cost associated with waste. Estimates of waste vary, but even conservative estimates suggest that up to twenty percent of expenditures on specialty drugs, for example, is waste. Waste typically occurs because of a mismatch between a prescribed drug or treatment method, and the patient receiving the treatment. For instance, certain individuals may have an adverse reaction to a drug, or may be relatively unresponsive to a particular treatment, where another patient would respond more favorably.

Unfortunately, the conventional approach of trial-and-error until a good match of patient to treatment is found is simply unworkably expensive for new and developing treatments, and may undesirably lead to the denial of treatments to patients who could greatly benefit from them. Consequently, there is a need for a treatment decision solution providing a graphical user interface (GUI) enabling a user to quickly and easily identify a substantially optimal match of a patient to a medication or other therapeutic treatment.

### SUMMARY

There are provided exemplary implementations of a treatment decision interface device and graphical user interface (GUI), as well as methods for their use, substantially as shown in and/or described in connection with at least one of the figures, and as set forth more completely in the claims.

### BRIEF DESCRIPTION OF THE DRAWINGS

FIG. 1 shows a diagram of an exemplary treatment decision interface device in combination with a treatment decision system, according to one implementation;

FIG. 2 shows a more detailed exemplary implementation of a treatment decision interface device and graphical user interface (GUI);

FIG. 3 is a flowchart presenting an exemplary method for use by a treatment decision interface device and GUI;

FIG. 4 shows an exemplary main screen of a GUI provided on a display of a treatment decision interface device, according to one implementation;

FIG. 5 shows an exemplary patient data screen of a GUI provided on a display of a treatment decision interface device, according to one implementation;

FIG. 6A shows an exemplary treatment query screen of a GUI provided on a display of a treatment decision interface device, according to one implementation;

FIG. 6B shows an exemplary treatment query sub-screen of a GUI provided on a display of a treatment decision interface device, according to one implementation; and

FIG. 7 shows an exemplary reporting screen of a GUI provided on a display of a treatment decision interface device, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, advances in pharmaceutical and basic medical research have resulted in the availability of new medications and new treatment protocols that give hope to many patients who previously had faced a bleak health future. However, and as also noted above, many of these cutting edge treatments are extremely costly, and leave insurers and other entities responsible for paying for patient care in the unenviable position of facing unsustainable costs, or restricting access to powerful and beneficial treatments.

The present application addresses the financial and ethical dilemmas described above, as well as analogous challenges in the provision of healthcare treatment, by providing implementations of a treatment decision interface device and method designed to improve clinical outcomes for insurers and other healthcare payer entities, healthcare providers, and patients. According to one implementation, such a device and method may be used to reduce or eliminate waste by providing a graphical user interface (GUI) enabling a user to quickly and easily identify a substantially optimal match of a patient to a medication or other therapeutic treatment.

In some implementations, the treatments determined using the disclosed treatment decision interface device and GUI may be relatively new prescription drugs, such as biologics or other costly specialty drugs. It is noted that for the purposes of the present application, a “biologic” or “biological medical product” is any pharmaceutical drug manufactured in, extracted from, or at least partially synthesized from biological sources, in contrast to traditional pharmaceutical drugs that are chemically synthesized. It is further noted that, as used herein, a “specialty drug” is a costly prescription medication, which may be chemically synthesized or produced as a biologic, and is used to treat complex, chronic conditions such as hepatitis C, cancer, multiple sclerosis, and rheumatoid arthritis, for example. The cost associated with use of a specialty drug may range from a few thousand dollars, up to approximately one hundred thousand dollars for a therapeutic course of treatment.

More generally, however, the treatment decision determinations performed using the treatment decision interface device and GUI disclosed in the present application can be applied across a wide variety of treatment modalities. That is to say, in some implementations, the treatment decision interface device and GUI disclosed in the present application may be utilized to identify substantially optimal treatment types other than specialty drug treatment, and/or may evaluate fundamentally different treatment modalities against one another. Examples of other treatment modalities include immunotherapy, gene therapy, proton therapy, robotic surgical technologies, and even the more conventional use of common prescription medications, as well as established chemotherapy and x-ray therapy protocols, to name a few.

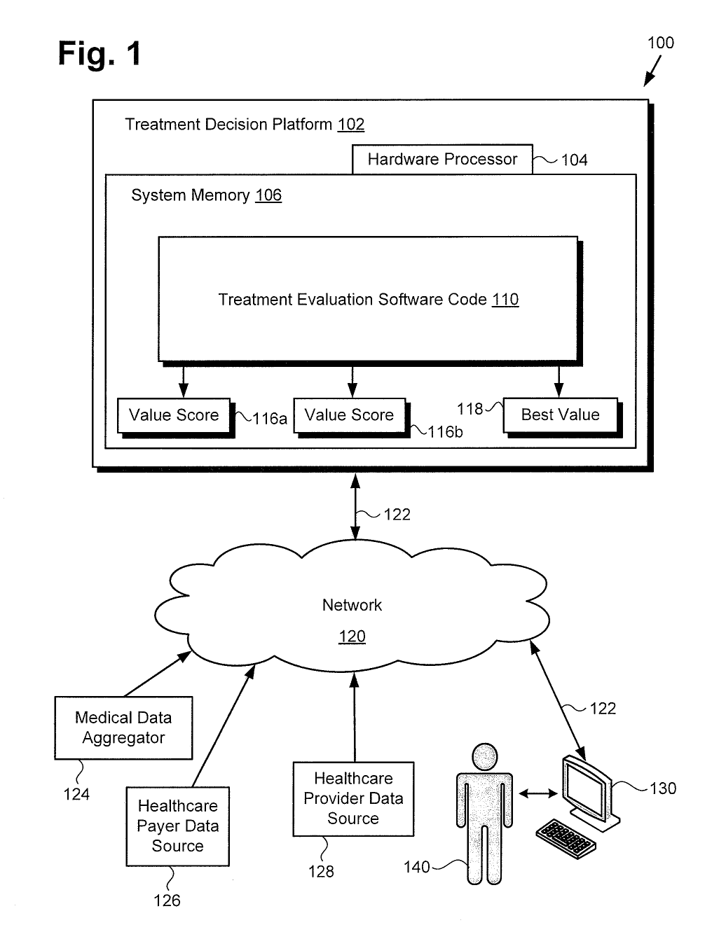

FIG. 1 shows a diagram of an exemplary treatment decision interface device in combination with a treatment decision system, according to one implementation. Treatment decision system 100 includes treatment decision platform 102, which itself includes hardware processor 104 and system memory 106 storing treatment evaluation software code 110. As shown in FIG. 1, treatment decision system 100 is situated within a communications environment including network 120, treatment decision interface device 130, user 140, medical data aggregator 124, healthcare payer data source 126, and healthcare provider data source 128. Also shown in FIG. 1 are first value score 116a, second value score 116b, best value 118, and network communication links 122 interactively connecting treatment decision interface device 130, medical data aggregator 124, healthcare payer data source 126, and healthcare provider data source 128 with treatment decision platform 102.

According to the implementation shown in FIG. 1, user 140 may utilize treatment decision interface device 130 to interact with treatment decision platform 102 over network 120. User 140 may represent an insurer or other healthcare payer entity, and thus may be a utilization manager or coordinator, for example. Alternatively, user 140 may be a healthcare provider, such as a physician, physician's assistant, pharmacist, or nurse practitioner, to name a few examples. User 140 may utilize client system 130 to access treatment evaluation software code 110.

In one such implementation, treatment decision platform 102 may correspond to one or more web servers, accessible over a packet network such as the Internet. For example, treatment decision system 100 may include one or more treatment decision platforms 102, such as computer servers for example, which may be co-located, or may form an interactively linked but distributed system, such as a cloud based system. Alternatively, treatment decision platform 102 may correspond to one or more servers supporting a local area network (LAN), or included in another type of limited distribution network.

Hardware processor 104 is configured to execute treatment evaluation software code 110 to receive use case data and outcome history data for each of multiple treatments, such as specialty drugs, for example. According to various implementations of the present treatment decision system, data received from any or all of medical data aggregator 124, healthcare payer data source 126, and healthcare provider data source 128, can include such use case data and outcome history data. Hardware processor 104 is further configured to execute treatment evaluation software code 110 to receive healthcare profiling data for a patient population diagnosed with a condition treatable using the treatments for which use case data and outcome history data have been received. Once again, any or all of medical data aggregator 124, healthcare payer data source 126, and healthcare provider data source 128 can provide the healthcare profiling data.

Hardware processor 104 is also configured to execute treatment evaluation software code 110 to generate health status data for patient subpopulations within the general patient population for which healthcare profiling data was received. For example, hardware processor 104 may execute treatment evaluation software code 110 to segregate a patient population diagnosed with a particular condition into patient subpopulations associated with health status data in the form of a patient genotype common to the patient subpopulation, a treatment previously received for the condition by members of the patient subpopulation, and the presence or absence of complications or aggravating factors in common for members of the patient subpopulation.

In one exemplary implementation, treatment decision system 100 may receive a query from user 140 of treatment decision interface device 130, via network 120. Such a query may regard suitability of use of one or more of the treatments for which use case data and outcome history data have been received, by a patient identifiable with one or more of the patient subpopulations for which health status data has been generated, for treatment of a particular condition.

In response to such a query, hardware processor 104 is configured to execute treatment evaluation software code 110 to transform the use case and outcome history data, and the health status data into value scores corresponding respectively to a value of the treatments for treatment of the queried condition in the queried patient. Hardware processor 104 is further configured to execute treatment evaluation software code 110 to report a value score, such as first value score 116a and second value score 116b, for each of the treatments included in the query. In addition, in some implementations, hardware processor 104 may be configured to execute treatment evaluation software code 110 to generate one or more treatment recommendations, corresponding for example to best value 118, for any treatments having a higher value score than the treatment or treatments included in the query.

It is noted that although FIG. 1 depicts first value score 116a, second value score 116b, and best value 118 as residing in system memory 106, in some implementations, first value score 116a, second value score 116b, and/or best value 118 may be copied to non-volatile storage (not shown in FIG. 1), or may be transmitted to treatment decision interface device 130 via network 120. It is further noted that although treatment decision interface device 130 is shown as a computer workstation in FIG. 1, that representation is provided merely as an example. In other implementations, treatment decision interface device 130 may be a mobile communication device, such as a smartphone, or a personal computer (PC) implemented as any of a desktop computer, a laptop computer, or a tablet computer, for example.

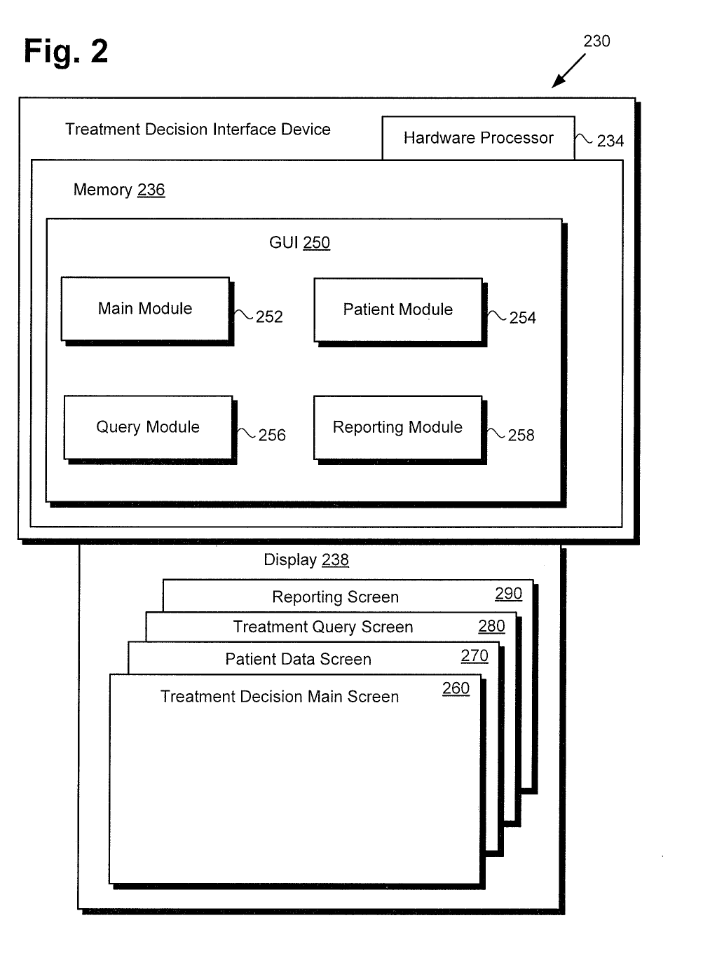

FIG. 2 shows a more detailed exemplary implementation of a treatment decision interface device and GUI. As shown in FIG. 2, treatment decision interface device 230 includes hardware processor 234, memory 236 storing GUI 250, and display 238 for presenting treatment decision main screen 260, patient data screen 270, treatment query screen 280, and reporting screen 290. Treatment decision interface device 230 corresponds in general to treatment decision interface device 130, in FIG. 1, and may share any of the characteristics attributed to that corresponding feature in the present application.

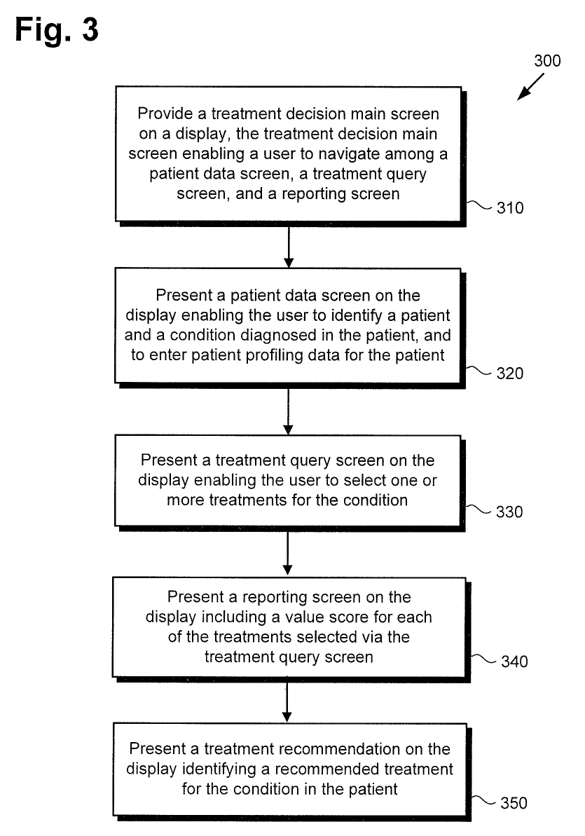

As further shown in FIG. 2, GUI 250 includes several modules for facilitating interaction by a user, such as user 140, in FIG. 1, with GUI 250. Among the modules included in GUI 250 are main module 252, patient module 254, query module 256, and reporting module 258. It is noted that the functionality of main module 252, patient module 254, query module 256, and reporting module 258 will be described below with reference to flowchart 300, in FIG. 3.

Hardware processor 234 may be the central processing unit (CPU) for treatment decision interface device 230, for example, in which role hardware processor 234 runs the operating system for treatment decision interface device 230 and executes GUI 250. In the exemplary implementation of FIG. 2, a user of treatment decision interface device 230, such as user 140, in FIG. 1, can utilize GUI 250 to obtain first value score 116a, second value score 116b, and best value 118, via reporting screen 290. Thus, according to the exemplary implementation shown in FIG. 2, treatment decision interface device 230 may be utilized to identify a substantially optimal treatment for a particular patient.

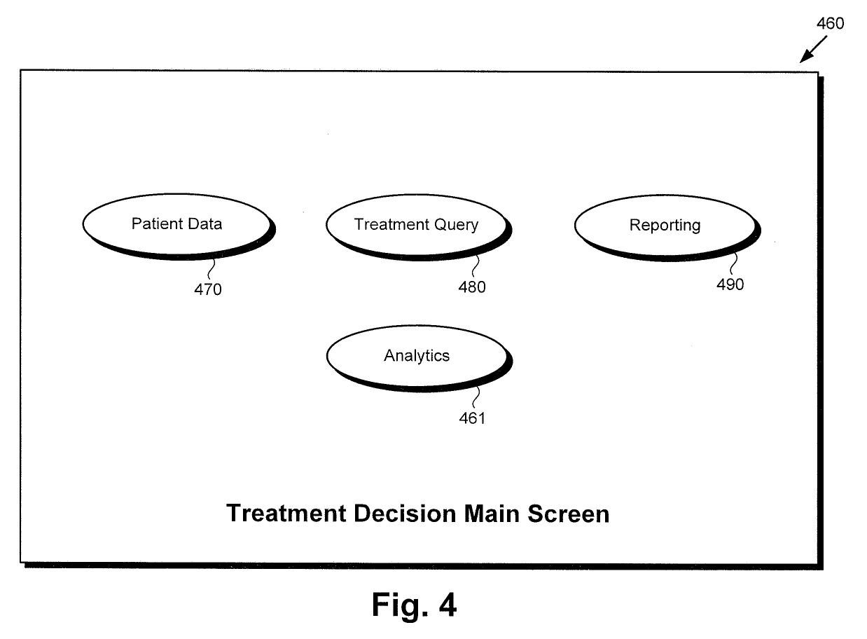

Example implementations of the present inventive concepts will be further described below with reference to FIG. 3, and FIGS. 4, 5, 6, and 7 (hereinafter “FIGS. 4-7”). FIG. 3 presents flowchart 300 outlining an exemplary method for use by treatment decision interface device 130/230 including GUI 250. FIGS. 4-7 show user interaction screens provided by GUI 250, executed by hardware processor 234, through use of respective main module 252, patient module 254, query module 256, and reporting module 258, and corresponding respectively to treatment decision main screen 260, patient data screen 270, treatment query screen 280, and reporting screen 290.

Referring to FIGS. 1, 2, 3, and 4 in combination, flowchart 300 begins with providing treatment decision main screen 260/460 enabling user 140 to navigate among patient data screen 270, treatment query screen 280, and reporting screen 290 (action 310). Treatment decision main screen 260/460 is provided on display 238 of treatment decision interface device 130/230 by GUI 250, executed by system processor 234, and through use of main module 252.

As shown in FIG. 4, treatment decision main screen 260/460 functions as a dashboard enabling user 140 to navigate to any of patient data screen 270, treatment query screen 280, and reporting screen 290 by activating its respective patient data screen selector 470, treatment query screen selector 480, or reporting screen selector 490. In addition, in some implementations, treatment decision main screen 260/460 may further enable user 140 to utilize analytics screen selector 461 to navigate to analytics screens described in greater detail below. Each of patient data screen selector 470, treatment query screen selector 480, reporting screen selector 490, and analytics screen selector 461 may be implemented as a button or tab selectable by user 140 via a touchscreen input or via a mouse-click, for example.

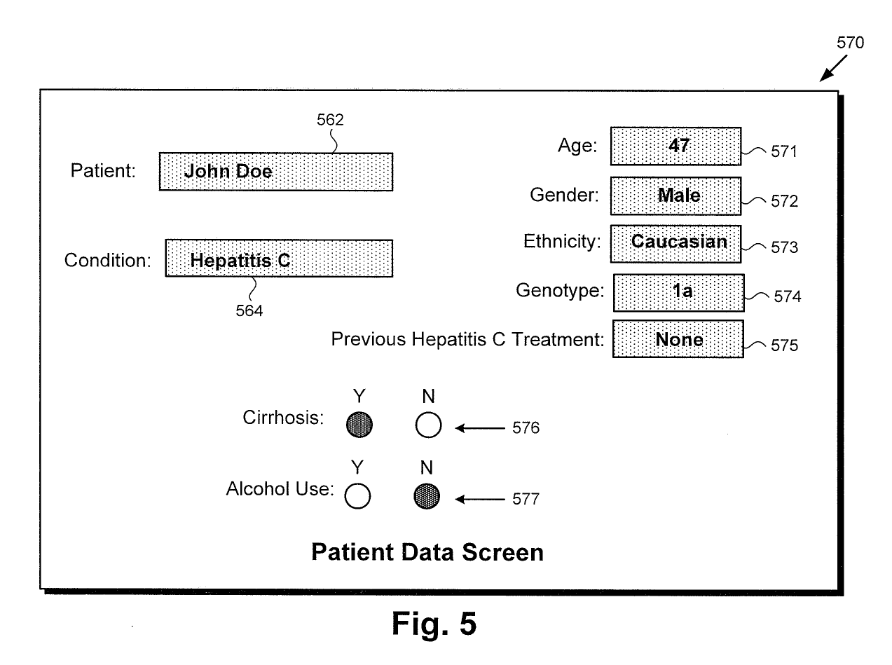

Referring to FIG. 5 in combination with FIGS. 1, 2, and 3, flowchart 300 continues with presenting patient data screen 270/570 enabling user 140 to identify patient 562 and condition 564 diagnosed in patient 562, as well as to enter patient profiling data for patient 562 (action 320). Patient data screen 270/570 is provided on display 238 of treatment decision interface device 130/230 by GUI 250, executed by system processor 234, and through use of patient module 254.

As shown by FIG. 5, patient data screen 270/570 of GUI 250 enables user 140 to identify patient 562 and condition 564 by entering a patient identifier and a condition identifier in their respective fields. According to the exemplary implementation of FIG. 5, patient 562 and condition 564 are identified by name. However, in other implementations, patient 562 and condition 564 may be identified using other types of identifiers, such as by a respective patient identification number and diagnostic code, for example.

Moreover, although the specific example depicted in FIG. 5 shows that the identification of patient 562 and condition 564 has been entered in free form by user 140, such as by means of a keyboard for example, in other implementations, patient 562 and/or condition 564 may be selected by user 140 via a dropdown menu or using another type of selection tool. As noted above, in some implementations, GUI 250 may be configured to receive inputs from user 140 via a keyboard. However, in other implementations, GUI 250 may be implemented as a touch screen user interface, and/or may be configured to receive inputs from user 140 via another type of input device, such as a mouse or pressure pad, or as voice commands spoken by user 140, for example.

As shown in FIG. 5, according to the present exemplary implementation, user 140 has identified patient 562 as John Doe and has identified condition 564 as hepatitis C. Patient profiling data may be any data describing patient 562 and relevant to condition 564. For example, patient profiling data may include age 571, gender 572, ethnicity 573, and genotype 574 of patient 562 diagnosed with condition 564. In addition, patient profiling data can include whether and what type of previous treatment 575 patient 562 has received for condition 564.

As noted above, according to the exemplary implementation shown by the present figures, condition 564 with which patient 562 has been diagnosed and for which a treatment decision is sought, is hepatitis C. In that specific case, additional patient profiling data relevant to patient 562 may include whether patient 562 presents with liver cirrhosis 576, as well as whether patient 562 consumes alcohol 577. It is noted, however, that in other implementations, the patient profiling data that user 140 may enter via patient data screen 270/570 of GUI 250 may include more parameters, such as many more parameters, than the exemplary parameters corresponding respectively to reference numbers 571-577.

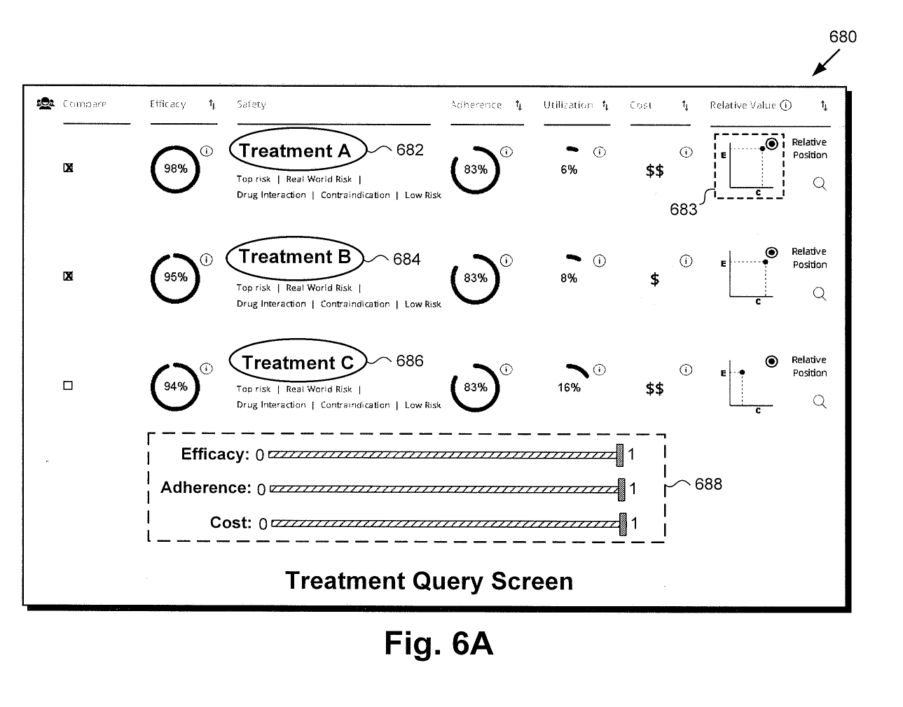

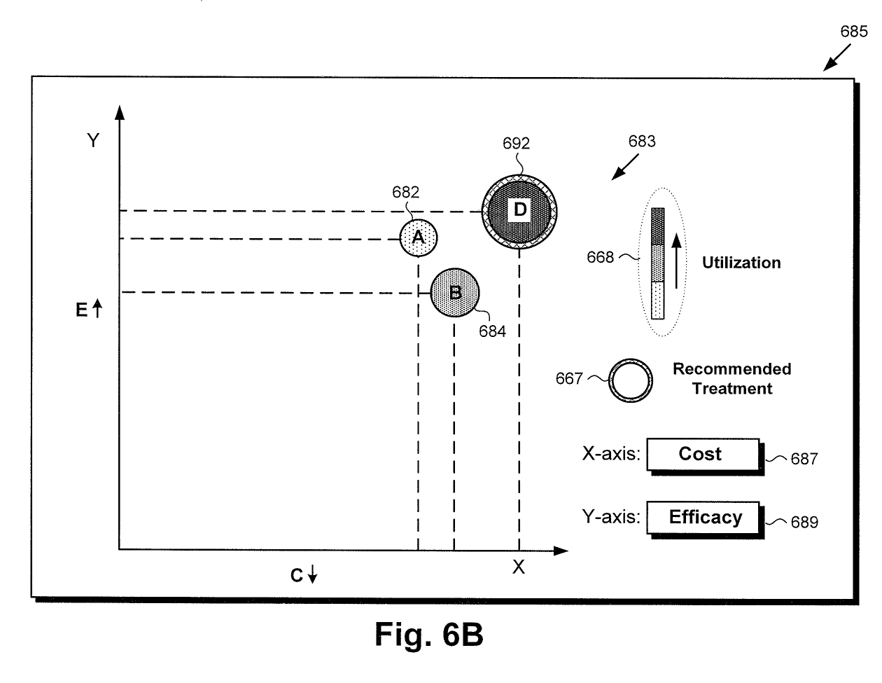

Referring to FIG. 6A in combination with FIGS. 1, 2, and 3, flowchart 300 continues with presenting treatment query screen 280/680 enabling user 140 to select one or more treatments for condition 564 (action 330). Treatment query screen 280/680 is provided on display 238 of treatment decision interface device 130/230 by GUI 250, executed by system processor 234, and through use of query module 256.

As shown in FIG. 6A, treatment query screen 280/680 enables user 140 to select and compare among three exemplary treatments for condition 564, including “Treatment A” 682, “Treatment B” 684, and “Treatment C” 686. As further shown in FIG. 6A, user 140 has selected “Treatment A” and “Treatment B” for comparison. Continuing with the hepatitis C focused exemplary implementation introduced above, “Treatment A” 682, “Treatment B” 684, and “Treatment C” 686 may correspond to drug treatments for hepatitis C in a particular patient using respective specialty “Drug A”, specialty “Drug B”, and specialty “Drug C.”

However, and as noted above, although the one or more treatments selectable by user 140 via treatment query screen 280/680 can include prescription drug treatments, including drug treatments utilizing biologics and other costly specialty drugs, other treatment options may be selectable. For example, as an alternative to, or in addition to, drug treatments, other treatments that may be selectable for treatment of condition 564 in patient 562 include immunotherapy, gene therapy, proton therapy, robotic surgical technologies, and even the more conventional use of common prescription medications, as well as established chemotherapy and x-ray therapy protocols, for example.

In addition to enabling selection of any or all of “Treatment A” 682, “Treatment B” 684, and “Treatment C” 686, by user 140, treatment query screen 280/680 may also present parameters derived from real world use case and outcome history data by treatment decision system 100, using treatment evaluation software code 110 executed by hardware processor 104. As shown in FIG. 6A, those parameters may include the efficacy of each treatment, the adherence of each treatment, the utilization of each treatment, the cost of each treatment, and the relative value of each treatment expressed as a graph, such as exemplary graph 683, plotting efficacy versus cost. Also shown in FIG. 6A is weighting tool 688 enabling user 140 to selectively emphasize any of efficacy, adherence, and cost, for example, when comparing “Treatment A” to “Treatment B.”

For the purposes of the present application, the efficacy of a treatment, or simply “efficacy” (E), is a measure of the effectiveness of the treatment based on real world evidence. Efficacy is defined as the percentage of patients within a particular patient subpopulation corresponding to patient 562 for whom remission or recovery occurs after completion of the treatment protocol. Returning to the example in which a specialty drug is used for treatment of hepatitis C in a particular patient subpopulation, efficacy may be expressed as follows:

E (%)=N_{SVR}_{_}₁₂_{_}₀/N_{SP}*100 (Equation 1)

Where: SVR 12 is the Sustained Virological Response on a gap of twelve weeks after completion of a prescribed treatment period, N_{SVR}_{_}₁₂_{_}₀ is the number of patients within the patient subpopulation for whom SVR 12 is substantially zero, or negligible, and N_{SP} is the total number of patients in the patient subpopulation receiving the treatment. Adherence of a treatment, or simply “adherence” (A), is a measure of the degree with which patients tend to comply with a particular treatment. In the case of drug treatment, one measure of adherence is the ratio of the drug dosage actually consumed by patients over a treatment period to the prescribed dosage over the treatment period. It is noted that adherence is an aggregated measure across all patients within a subpopulation receiving the same treatment. For example, adherence with respect to a drug treatment may be determined using the medication possession ratio (MPR), as known in the art, for a patient subpopulation treated using the same drug.

Utilization of a treatment, or simply “utilization” (U), is defined as the number of patients within the patient subpopulation corresponding to patient 562 to whom a particular treatment has been prescribed, divided by the total number of patients making up the patient subpopulation. Thus, utilization of treatment “X” may be expressed as a percentage as follows:

U_{X}(%)=N_{X}/N_{TSP}*100 (Equation 2)

Where: N_{X} is the number of patients within the patient subpopulation to whom treatment X has been prescribed, and N_{TSP} is the total number of patients making up the patient subpopulation.

The cost of a treatment, or simply “cost” (C) is the cost of the treatment over the prescribed treatment period. For example, the cost of a drug treatment administered daily for ten weeks is the cumulative cost of the entire prescribed drug dosage over the ten week treatment period.

FIG. 6B shows exemplary treatment query sub-screen 685 of GUI 250 showing a more detailed example of graph 683, according to one implementation. As shown in FIG. 6B, graph 683 plots descending cost on the X-axis, and ascending efficacy on the y-axis. As further shown in FIG. 6B user 140 can select the variables plotted on graph 683 using X-axis selector 687 and Y-axis selector 689. It is noted that although the exemplary implementation shown in FIG. 6B depicts a graph of efficacy and cost, in other implementations, user 140 can select other variables for presentation on graph 683. For example, any of efficacy, cost, adherence, or utilization could be plotted on the X-axis by selecting that variable using X-axis selector 687, and any other of efficacy, cost, adherence, or utilization could be plotted on the Y-axis by selecting that other variable using Y-axis selector 689.

Also shown in FIG. 6B is data circle 682 corresponding to “Treatment A” 682 in FIG. 6A, data circle 684 corresponding to “Treatment B” 684 in FIG. 6A, and data circle 692 corresponding to a previously unidentified “Treatment D” providing a substantially optimal balance of efficacy and cost according to the weighting emphasis selected by user 140 through use of weighting tool 688 in FIG. 6A. According to the present exemplary implementation, the size or color of each of data circles 682, 684, and 692 i.e., their respective diameters or line fills in FIG. 6B, correspond to the relative utilization of those treatments in the patient subpopulation corresponding to patient 562, as shown by utilization color key 668. In addition, treatment query sub-screen 685 of GUI 250 identifies “Treatment D” as a recommended treatment by surrounding data circle 692 corresponding to “Treatment D” with highlight ring 667.

As noted above by reference to FIG. 4, in some implementations, treatment decision main screen 260/460 may further enable user 140 to utilize analytics screen selector 461 to navigate to analytics screens providing more detailed information regarding any of the variables, i.e., efficacy, cost, adherence, and utilization, that may be used to determine first value score 116a and second value score 116b. Moreover, in some implementations, user 140 can utilize analytics screen selector 461 to navigate to one or more machine learning screens providing specific assessments of condition 564 for patient 562. For example, such machine learning screens may display information predicting progression of condition 564 for patient 562, the likely adherence of patient 562 to a specific treatment, treatment prioritization for patient 562, cost assessments, and risk assessments, for example.

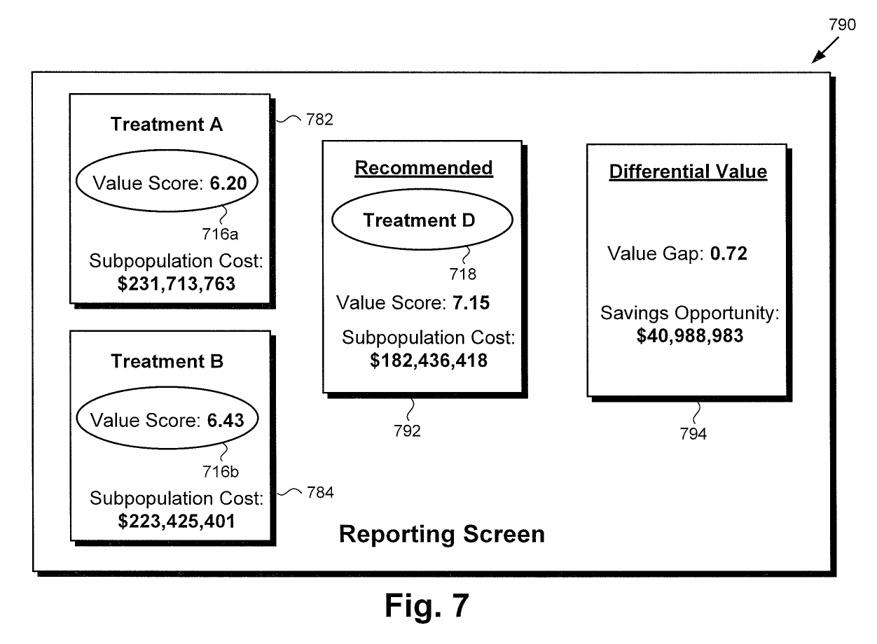

Referring to FIG. 7 in combination with FIGS. 1, 2, and 3, flowchart 300 continues with presenting reporting screen 290/790 including first value score 116a/716a and second value score 116b/716b for respective “Treatment A” 682/782 and “Treatment B” 684/784 selected via treatment query screen 280/680 (action 340). Reporting screen 290/790 is provided on display 238 of treatment decision interface device 130/230 by GUI 250, executed by system processor 234, and through use of reporting module 258.

First value score 116a/716a and second value score 116b/716b may be determined by treatment decision system 100, using treatment evaluation software code 110 executed by hardware processor 104. The value score (V) of a particular treatment may be determined using a weighted or non-weighted combination of efficacy, adherence, and cost, for example, as follows:

V=(w₁*E+w₂*A+w₃*C)/[100*(w₁+w₂+w₃)]*10 (Equation 3)

Where w₁, w₂, and w₃, are weighting factors in a range between zero and one, inclusive of one, and are applied respectively to efficacy, adherence, and cost.

It is noted that in implementations in which first value score 116a/716a and second value score 116b/716b are determined using a weighted combination of efficacy, adherence, and cost, the weighting factors w₁, w₂, and w₃ may be predetermined and fixed within treatment evaluation software code 110, or may be selectable or adjustable by user 140 using weighting tool 688, accessible via treatment query screen 280/680. That is to say, in some implementations, user 140 may have discretion to increase or reduce weighting factors w₁, w₂, and w₃ relative to one another. It is noted that where first value score 116a/716a and second value score 116b/716b are determined using a non-weighted combination of efficacy, adherence, and cost, each of w₁, w₂, and w₃ may be set equal to one (w₁=w₂=w₃=1).

In addition to efficacy, adherence, and cost, in some implementations, first value score 116a/716a and second value score 116b/716b may be further determined based on the overall utilization of the treatment in the patient subpopulation corresponding to patient 562, for example. Thus, it is emphasized that in some implementations, user 140 may select the variables included in Equation 3 and used to determine first value score 116a/716a and second value score 116b/716b, and/or may select the weighting applied to the included variables by Equation 3. As a result, user 140 can utilize GUI 250 to evaluate one or more queried treatments in a way that balances the interests of the different parties, i.e., insurers or other healthcare payer entities, healthcare providers, and patients, affected by a resulting treatment decision.

Reporting screen 290/790 may be utilized by user 140 in determining a treatment decision for treatment of condition 664 in patient 662. As shown in FIG. 7, according to reporting screen 290/790 first value score 116a/716a for “Treatment A” 682/782 used in the treatment of hepatitis C in a particular patient subpopulation is 6.20. In addition, the cost attributable to use of “Treatment A” 682/782 across the patient subpopulation is reported to be $231,713,763.00. As further shown in FIG. 7, according to reporting screen 290/790 second value score 116b/716b for “Treatment B” 684/784 used in the treatment of hepatitis C in the same patient subpopulation is 6.43. Moreover, the cost attributable to use of “Treatment B” 684/784 across the patient subpopulation is reported to be $223,425,401.00. Thus, due to its higher value score and lower cost, “Treatment B” 684/784 may be determined to be preferable to “Treatment A” 682/782 for treating condition 564 in patient 562.

Although in some implementations, reporting screen 290/790 may simply include first value score 116a/716a and second value score 116b/716b for respective “Treatment A” 682/782 and “Treatment B” 684/784 selected via treatment query screen 280/680, in other implementations, reporting screen 290/790 may further present treatment recommendation 792 identifying best value 118/718 (action 350). It is noted that treatment recommendation 792 identifies as best value 118/718 the same “Treatment D” identified by data circle 692 in FIG. 6B.

In implementations in which treatment recommendation 792 identifying best value 118/718 is presented in action 350, that treatment recommendation 792 may be generated by, and best value 118/718 may be determined by, treatment evaluation software code 110 of system 100, executed by hardware processor 104. As shown in FIG. 7, treatment recommendation 792 identifies “Treatment D” as best value 118/718 having a higher value score of 7.15 than first value score 116a/716a of 6.20 for “Treatment A” 682/782 included in the query, and higher than second value score 116b/716b of 6.43 for “Treatment B” 684/784 also included in the query. In addition to the value score for best value 118/718, treatment recommendation 792 includes the cost attributable to use of best value 118/718 “Treatment D” across the patient subpopulation corresponding to patient 562, which is reported to be $182,436,418.00.

It is noted that “Treatment D” identified in treatment recommendation 792 as best value 118/718 is not one of the treatments selected by user 140 via treatment query screen 280/480. Nevertheless, according to the present implementation, “Treatment D” is presented as the treatment recommendation for treatment of condition 564 in patient 562 because “Treatment D” is identified as having a higher value score than any treatment selected via treatment query screen 280/480. However, in some implementations, the treatment presented as the treatment recommendation for treatment of condition 564 in patient 562 may be the treatment selected via the treatment query screen 280/480 having the highest value score.

As further shown in FIG. 7, in some implementations, reporting screen 290/790 may also include differential value 794 showing the value gap separating best value 118/718 “Treatment D” from the next best value represented by “Treatment B” 684/784. In addition, according to the exemplary implementation shown by FIG. 7, reporting screen 290/790 also presents the savings opportunity across the patient subpopulation corresponding to patient 562 if best value 118/718 “Treatment D” is prescribed for patient 562, rather than queried “Treatment B” 684/784 for the treatment of condition 564.

As shown by reporting screen 290/790, best value 118/718 “Treatment D” has a value score that is 0.72 higher than second value score 116b/716b of queried “Treatment B” 684/784. Moreover, according to reporting screen 290/790, over forty million dollars in savings can be realized by an insurer or other healthcare payer entity if best value 118/718 “Treatment D” 684/784 is substituted for queried “Treatment B” 684/784 for treatment of condition 564 in the patient subpopulation corresponding to patient 562.

Thus, the various implementations of a treatment decision interface device and method disclosed in the present application address the serious financial and ethical dilemmas posed by decisions to permit or deny patient access to extremely costly but highly therapeutic treatments. The treatment decision interface devices and methods disclosed herein may be used to reduce or eliminate waste by providing a GUI enabling a user to quickly and easily identify a substantially optimal match of a patient to a medication or other therapeutic treatment, thereby improving clinical outcomes for insurers, healthcare providers, and patients alike.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A treatment decision interface device comprising:
a hardware processor;
a memory;
a display; and
a graphical user interface (GUI) stored in the memory and executed by the hardware processor to:
provide a treatment decision main screen on the display enabling a user to navigate among a patient data screen, a treatment query screen, and a reporting screen;
present a patient data screen on the display enabling the user to identify a patient and a condition diagnosed in the patient, and to enter patient profiling data for the patient;
present a treatment query screen on the display enabling the user to select one or more treatments for the condition; and
present a reporting screen on the display including a value score for each of the one or more treatments selected via the treatment query screen, the value score corresponding respectively to a value of each of the one or more treatments for treating the condition in the patient.

2. The treatment decision interface device of claim 1, wherein the hardware processor executes the GUI to further present a treatment recommendation on the display, the treatment recommendation identifying one of the one or more treatments selected via the treatment query screen as a recommended treatment for the condition in the patient.

3. The treatment decision interface device of claim 1, wherein the hardware processor executes the GUI to further present a treatment recommendation on the display, the treatment recommendation identifying a treatment having a higher value score than any of the one or more treatments selected via the treatment query screen.

4. The treatment decision interface device of claim 1, wherein the treatments comprise specialty drugs.

5. The treatment decision interface device of claim 1, wherein the treatments comprise biologics.

6. The treatment decision interface device of claim 1, wherein the value score for each of the one or more treatments selected via the treatment query screen is determined based on an efficacy of each treatment, an adherence of each treatment and a cost of each treatment in a patient subpopulation corresponding to the patient.

7. The treatment decision interface device of claim 1, wherein the treatment decision interface device is one of a mobile communication device, a tablet computer, a laptop computer, and a computer workstation.

8. A graphical user interface (GUI) of a treatment decision interface device having a hardware processor, a display and a memory storing the GUI for execution by the hardware processor, the GUI comprising:
a main module providing a treatment decision main screen on the display for enabling a user to navigate among a patient data screen, a treatment query screen, and a reporting screen;
a patient module presenting a patient data screen on the display for enabling the user to identify a patient and a condition diagnosed in the patient, and to enter patient profiling data for the patient;
a query module presenting a treatment query screen on the display for enabling the user to select one or more treatments for the condition; and
a reporting module presenting a reporting screen on the display, the reporting screen including a value score for each of the one or more treatments selected via the treatment query screen, the value score corresponding respectively to a value of each of the one or more treatments for treating the condition in the patient.

9. The GUI of claim 1, wherein the reporting module further presents a treatment recommendation on the display, the treatment recommendation identifying one of the one or more treatments selected via the treatment query screen as a recommended treatment for the condition in the patient.

10. The GUI of claim 8, wherein the reporting module further presents a treatment recommendation on the display, the treatment recommendation identifying a treatment having a higher value score than any of the one or more treatments selected via the treatment query screen.

11. The GUI of claim 8, wherein the treatments comprise specialty drugs.

12. The GUI of claim 8, wherein the treatments comprise biologics.

13. The GUI of claim 8, wherein the value score for each of the one or more treatments selected via the treatment query screen is determined based on an efficacy of each treatment, an adherence of each treatment and a cost of each treatment in a patient subpopulation corresponding to the patient.

14. The GUI of claim 8, wherein the treatment decision interface device is one of a mobile communication device, a tablet computer, a laptop computer, and a computer workstation.

15. A method of presenting a graphical user interface (GUI) on a display of a treatment decision interface device having a memory storing the GUI and a hardware processor executing the GUI from the memory, the method comprising:
providing, using the hardware processor, a treatment decision main screen on the display enabling a user to navigate among a patient data screen, a treatment query screen, and a reporting screen;
presenting, using the hardware processor, a patient data screen on the display enabling the user to identify a patient and a condition diagnosed in the patient, and to enter patient profiling data for the patient;
presenting, using the hardware processor, a treatment query screen on the display enabling the user to select one or more treatments for the condition; and
presenting, using the hardware processor, a reporting screen on the display including a value score for each of the one or more treatments selected via the treatment query screen, the value score corresponding respectively to a value of each of the one or more treatments for treating the condition in the patient.

16. The method of claim 15, further comprising presenting a treatment recommendation on the display, the treatment recommendation identifying one of the one or more treatments selected via the treatment query screen as a recommended treatment for the condition in the patient.

17. The method of claim 15, further comprising presenting a treatment recommendation on the display, the treatment recommendation identifying a treatment having a higher value score than any of the one or more treatments selected via the treatment query screen.

18. The method of claim 15, wherein the treatments comprise specialty drugs.

19. The method of claim 15, wherein the treatments comprise biologics.

20. The method of claim 15, wherein the value score for each of the one or more treatments selected via the treatment query screen is determined based on an efficacy of each treatment, an adherence of each treatment and a cost of each treatment in a patient subpopulation corresponding to the patient.
